(19) United States
(12) Patent Application Publication
(10) Pub. No.: US 2004/0120241 A1
(43) Pub. Date: Jun. 24, 2004

(54) Method and apparatus of recording optical information

(76) Inventors: Isao Kobayashi, Suita-shi (JP); Mamoru Shoji, Sakai-shi (JP); Atsushi Nakamura, Moriguchi-shi (JP); Takashi Ishida, Yawata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/685,443

(22) Filed: Oct. 16, 2003

(30) Foreign Application Priority Data
Oct. 18, 2002 (JP) 2002-304791

(51) Int. Cl. G11B 7/00

(52) U.S. Cl. 369/94; 369/47.53; 369/59.25; 369/53.24

(57) ABSTRACT

An optical disk has a plurality of information recording layers including a first recording layer and a second recording layer disposed at a farther position from a light source than the first recording layer. When recording data to the second recording layer of the optical disk, a radius of the outermost circumference of a data recordable range in the second recording layer is defined to be equal to or less than a radius of the outermost circumference of an area in which data is recorded in the first recording layer.

### BACKGROUND OF THE INVENTION

1. Technical Field

The present invention relates to a recording method and a recording apparatus for a multi-layer optical disk having plural recording layers and capable of recording and reproducing information optically in each recording layer.

2. Related Art

A wide variety of optical disks capable of recording and reproducing a huge quantity of information have been researched and developed. One of large-capacity optical disks is a double-sided optical disk consisting of two optical disks adhered together capable of recording and reproducing in both sides. However, in a field requiring frequent random access, for example, in video data recording media, aside from large recording capacity of optical disk, access to arbitrary data without turning over the sides is demanded, and the double-sided optical disk has a problem in this respect.

Instead, a multi-layer optical disk is proposed, in which a large capacity of data can be recorded in one optical disk, there are two or more recording layers in a random access optical disk, and information can be recorded and reproduced from one side.

For recording in recording layers of an optical disk, usually, since the recording layers are composed of phase change materials and organic pigment films, a laser beam is emitted to the recording medium surface to change optical characteristics, and thus pits are formed. In actual recording and reproducing of information in an optical disk having plural recording layers, when attempted to record in the recording layer of the inner side as seen from the laser beam emitting side, the power of the laser beam reaching the recording layer at the inner side varies due to difference in optical characteristics in the recorded or unrecorded recording layers at the nearer side, and adverse effects may be caused in recording and/or reproducing operation. By contrast, the following countermeasures are considered.

One method is to record dummy data in areas even if the areas are judged impossible to record during recording of data to make the recorded areas uniform so as to eliminate difference in optical characteristics, thereby making uniform the power of the laser beam reaching other layers (see WO 01/18799 (ex. see FIG. 24)).

Such a rewritable optical disk generally has a sector structure, and recording is done in sector units, and when recording or reproducing in an optical disk having plural recording layers, the following problems are involved.

Generally, a sector is composed of, as shown in FIG. 9B, an address area 116, a user area 120, gap areas 117, 119, and a buffer area 121. For the sake of simplicity of explanation, herein, a test emission area 118 is provided in the middle between the gap area to divide it into two sections 117 and 119.

The address area 116 is an area having address information as identification signal of each sector. The user data area 120 is an area for recording user data having a synchronizing signal at the beginning or end of the data within the sector. The test emission area 118 is an area disposed between the address area 116 and user data area 120, and used for adjusting the optical output of the semiconductor laser or measurement of the optimum optical output for recording. The first gap area 117 is disposed between the address area 116 and test emission area 118, and is a space area for preventing erasure of signal in the address area 116, for example, in the event of adjustment of optical output in the test emission area 118. The second gap area 119 is disposed between the test emission area 118 and user data area 120, and has the same role as the first gap area 117. The second gap area 119 can be recorded with the same signal as the synchronizing signal at the beginning of the user data when recording the user data in the user data area 120. The buffer area 121 is an area for absorbing the rotation precision of the motor of the optical disk drive.

Generally, the recording is not operated in all of the first gap area 117, test emission area 118, second gap area 119, and buffer area 121, the recorded state is not continuous, to be precise, and the optical characteristic is not uniform in the recording layer at the near position from the laser beam source, and the power of the laser beam reaching the recording layer at the farther position from the laser beam source is not uniform. Therefore, same as in the prior art, only recording the dummy data in the user data area 120 alone causes a problem in the optical characteristic.

This problem is specifically explained by referring to an example of two-layer disk. FIG. 9A shows a structure of an optical disk having a first recording layer 102 and a second recording layer 104. In the following, the description is made to the power of the laser beam reaching the second recording area in case that in the first recording area 102, the user data area is in recorded state, and the first gap area, second gap area and buffer area are in unrecorded state, and the middle portion of the test emission area is in recorded state. The area 501 is an area in which data has been already recorded, while the area 502 is an area in which data has not been yet recorded. A sector is composed of the address area 116, first gap area 117, test emission area 118, second gap area 119, user data area 120, and buffer area 121.

The first recording layer 102 and second recording layer 104 are composed of phase change material. The first recording layer 102 has an optical characteristic as shown in FIG. 10. The recording layer is in crystal state when data is not recorded. When the laser beam is irradiated to the recording layerlaser beam, amorphous pits are formed in the recording layer, and thereby data is recorded.

When laser beam 402 of same power is emitted to each area in the sector, the power of the laser beam reaching each area of the second recording layer 104 differs with the recorded state of the first recording layer 102. This is because the first recording layer 102 has optical characteristics different in transmissivity between crystal state and amorphous state. In the optical characteristics, the amorphous state has greater transmissivity than the crystal state. Accordingly, in the beam spot area of the laser beam 402, when the occupation rate of the recorded region of the first recording layer 102 is higher, a greater amount of the laser beam 402 reaches the second recording layer.

FIGS. 9C to 9E shows the power of the laser beam reaching the second recording layer 104 when the laser beam is emitted to the first recording layer 102, that is, the test emission area where data is not recorded, the user data area 120 in which data is recorded entirely, and the boundary portion of the user data area and buffer area where data is recorded in part, respectively. When the laser beam 402 is emitted to the user data area 120, the power of the laser beam reaching the second recording layer is the greatest. Accordingly, depending on whether the area in the sector in the first recording layer is recorded or unrecorded, there is a difference in the power of the reflected light from the second recording layer, so that distortion in reproduction signal or other problem may be caused.

### SUMMARY OF THE INVENTION

The invention is directed to solve the problems of the prior art, and it is hence an object thereof to present a recording method and a recording apparatus of an optical disk having a plurality of information recording layers capable of detecting stable reproduction signals from one recording layer with high reliability, without affected by difference of transmissivity due to recorded or unrecorded state of the other recording layer when reproducing the optical disk.

In a first aspect of the invention, provided is a method of recording data to an optical disk having a plurality of recording layers in which information can be recorded optically. The optical disk has a first recording layer and a second recording layer disposed at a farther position from a light source than the first recording layer. The method includes defining a radius of the outermost circumference of a data recordable range in the second recording layer to be equal to or less than a radius of the outermost circumference of an area in which data is recorded in the first recording layer, when recording data in the second recording layer.

In a second aspect of the invention, provided is a method of recording data to an optical disk having a plurality of recording layers in which information can be recorded optically. The optical disk has a first recording layer, and a second recording layer disposed at a farther position from a light source than the first recording layer. The optical disk has tracks divided into plural sectors, and each sector includes a buffer area at the end portion. The method includes recording predetermined dummy data to the buffer area.

In a third aspect of the invention, provided is an apparatus of recording data to an optical disk having a plurality of recording layers in which information can be recorded optically. The optical disk has a first recording layer, and a second recording layer disposed at a farther position from a light source than the first recording layer. The apparatus includes an optical head that emits a laser beam to the optical disk to record information, a driving controller that drives the optical head, and a controller for controlling the driving controller. When recording data in the second recording layer, the controller conducts a control so that a radius of the outermost circumference of a data recordable range in the second recording layer is equal to or less than a radius of the outermost circumference of an area in which data is recorded in the first recording layer.

In a fourth aspect of the invention, provided is an apparatus of recording data to an optical disk having a plurality of recording layers in which information can be recorded optically. The optical disk has a first recording layer, and a second recording layer disposed at a farther position from a light source than the first recording layer. The optical disk has tracks divided into plural sectors, each sector including a buffer area at the end portion.

The apparatus includes an optical head that emits a laser beam to the optical disk to record information, a driving controller that drives the optical head, and a controller for controlling the driving controller. The controller conducts the control so that predetermined dummy data is recorded to the buffer area.

(Effects of the Invention)

According to the invention, by recording dummy data in the areas in the sector, fluctuations of transmissivity are eliminated. Further, depending on the recording range in one recording layer at the laser beam emission side, the recordable range in other layers are limited and thus the power of the laser beam reaching other layers may be made uniform, so that recording and reproduction can be realized in a further stable state.

### BRIEF DESCRIPTION OF THE DRAWINGS

FIG. 1 is a block diagram of an optical disk apparatusapparatus according to the invention.

FIG. 2 is a structural diagram of an optical disk in which information is recorded or reproduced by the optical disk apparatusapparatus of the invention.

FIG. 3A is an explanatory diagram of wobble shape showing signal “0” when address information is included in the wobble shape of meandering track.

FIG. 3B is an explanatory diagram of wobble shape showing signal first recording layer and recording start position of the second recording layer.

FIG. 9 is a diagram explaining the effects of optical characteristics of the first recording layer on the laser beam reaching the second layer.

FIG. 10 is a diagram showing optical characteristics of the first recording layer.

### DETAIED DESCRIPTION OF THE PREFERRED EMBODIMENTS

Preferred embodiments of the invention are described below while referring to the accompanying drawings.

1. Configuration of Optical Disk Apparatus

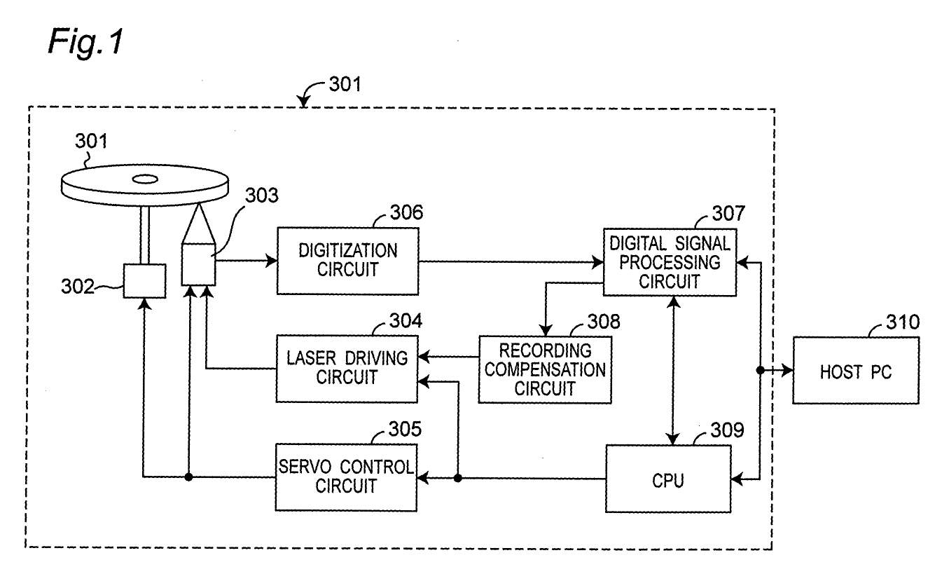

FIG. 1 is a block diagram of configuration of an optical disk apparatus according to the invention. The optical disk apparatus includes an optical disk drive 300 and a host PC 310 for controlling it.

The optical disk drive 300 includes a spindle motor 302, an optical head 303, a laser driving circuit 304, a servo control circuit 305, a digitization circuit 306, a digital signal processing circuit 307, a recording compensation circuit 308, and a CPU 309.

The spindle motor 302 rotates the optical disk 301. The optical head 303 emits a laser beam for recording data in the optical disk 301 or reproducing data from the optical disk 301, and outputs a reproduction signal electrically converted from the reflected light from the optical disk 301. The laser driving circuit 304 controls the power of the laser beam emitted from the optical head 303. The servo control circuit 305 conducts the rotation control of the spindle motor 302, the position control of the optical head 303, and focus and tracking control.

The digitization circuit 306 conducts amplification, filtering and binary coding of the reproduction signal obtained from the optical head 303, and generates a digital signal (a binary coded signal). The digitization circuit 306 has a PLL (not shown) in its inside, and generates a clock signal synchronized with the binary coded signal.

The digital signal processing circuit 307 demodulates the binary coded signal as specified, extracts address and corrects error at the time of reproduction, or adds error correction code to the recorded data, modulates as specified, and generates modulated data at the time of recording. In this case, dummy data is added to the recorded data as required.

The recording compensation circuit 308 transforms the modulated data into optical modulated data composed of a series of pulses, and further adjusts finely the pulse width and amplitude of the optical modulated data, and transforms it into a recording pulse signal suited to pit formation. The CPU 309 controls the entire optical disk drive. The host PC 310 has a computer (not shown) and an operating system (not shown), and requests recording and reproduction to the optical disk drive 300.

2. Structure of Optical Disk

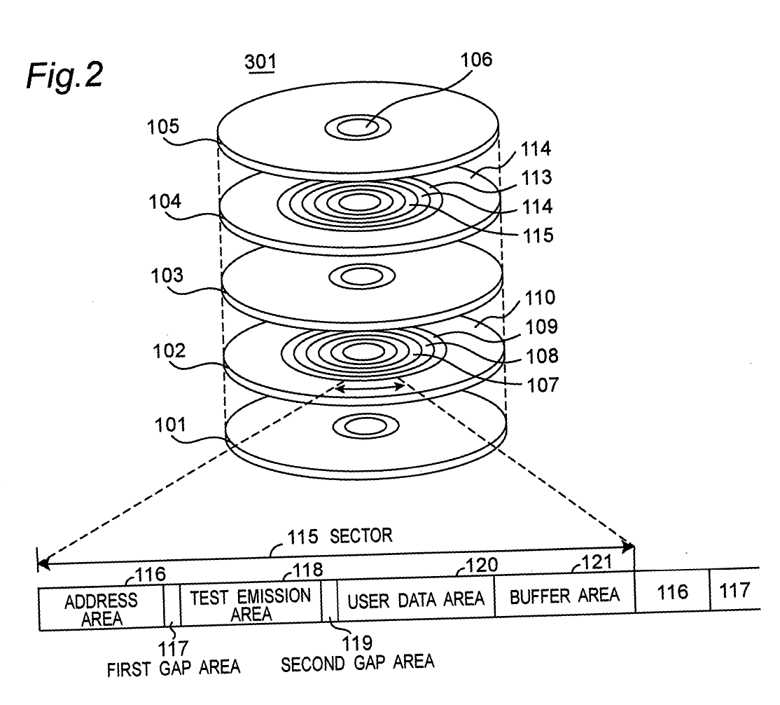

FIG. 2 is a diagram showing a structure of the optical disk 301 for recording and reproducing data by the optical disk apparatus according to the embodiment. The optical disk 301 physically contains a first substrate 101, a first recording layer 102, a second recording layer 104, and a second substrate 105. A clamp hole 106 is formed in the center of the optical disk 301.

The first and second substrates 101 and 105 are made of polycarbonate resin, and protect the first and second recording layers 102 and 104. The first recording layer 102 and second recording layer 104 are adhered with an adhesive resin 103, and the adhesive resin 103 is UV hardened resin or the like. The clamp hole 106 is provided for transmitting the rotation of the spindle motor by the shaft bar to rotate the disk.

The first recording layer 102 logically includes a lead-in area 107, a defect list area 108, a spare area 109, and a data area 110. Similarly, the second recording layer 104 includes a lead-in area 111, a defect list area 112, a spare area 113, and a data area 114.

The first recording layer 102 and second recording layer 104 have a plurality of spiral or concentric tracks (not shown). A track includes a plurality of sectors 115. A sector 115 includes an address area 116, a first gap area 117, a test emission area 118, a second gap area 119, a user data area 120, and a buffer area 121. The address area 116 has address information. Usually, signal is not recorded in the first gap area 117, test emission area 118, and second gap area 119. The user data area 120 has user data having a synchronizing signal at the beginning or end and stored therein. The buffer area 121 absorbs the rotation precision of the motor.

In the first recording layer 102 and second recording layer 104, information recorded in a specified modulation rule, for example, 1-7 modulation rule is recorded as pits on each sector 115. Pits are formed by changing the optical characteristics of the material of the recording layer with the power of the laser beam. The reproduction or recording of the information to the optical disk is performed by emitting the laser beam from the first substrate 101 side. The second recording layer 104 is recorded or reproduced by the laser beam passing through the first recording layer. In this embodiment, the recording layer is made of phase change material, but it may be also made of organic pigment film. Also in the embodiment, recording sequentially from the inner circumference to the outer circumference of the first recording layer, and subsequently the recording on the second recording layer is started from the outer circumference to the inner circumference. However the recording may be also started from the second recording layer. The recording direction is also not limited to the above described way.

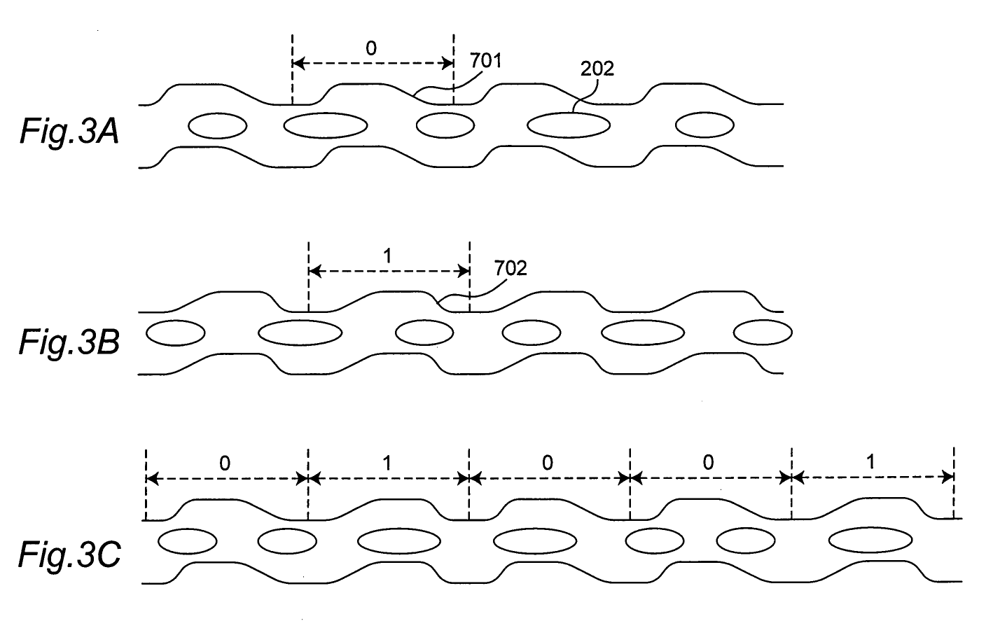

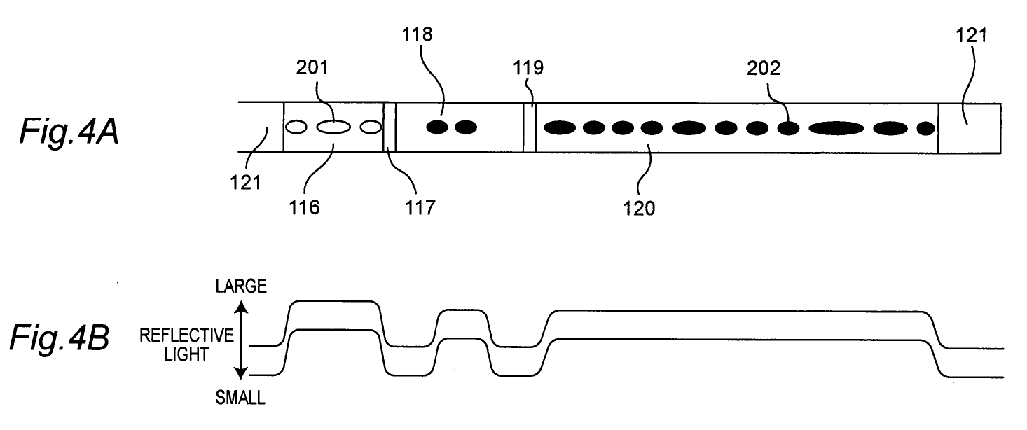

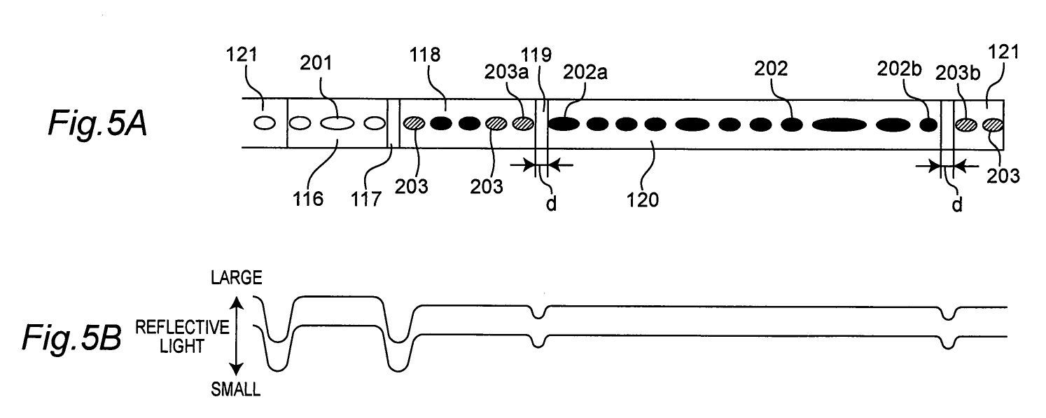

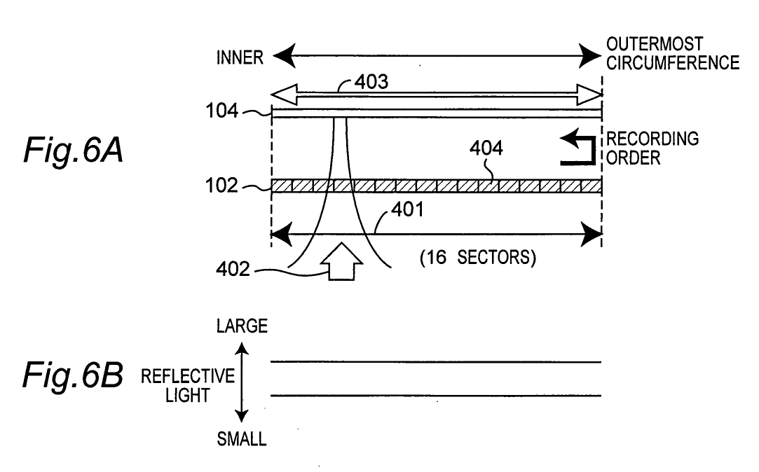

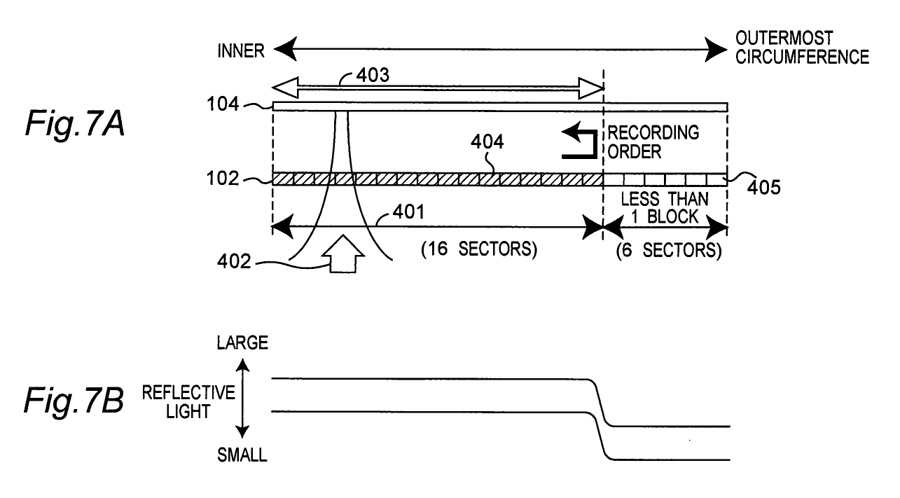

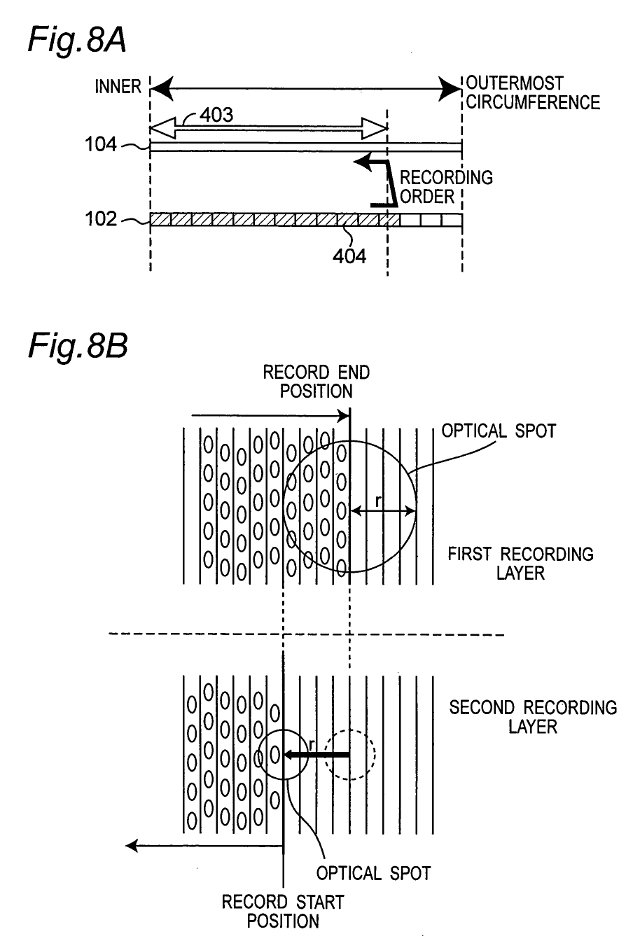

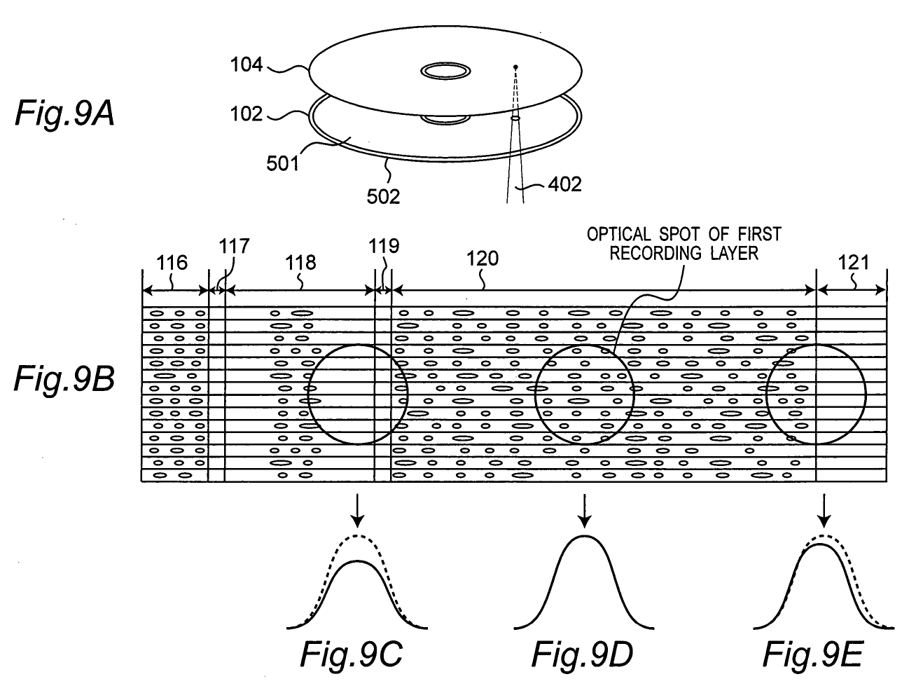

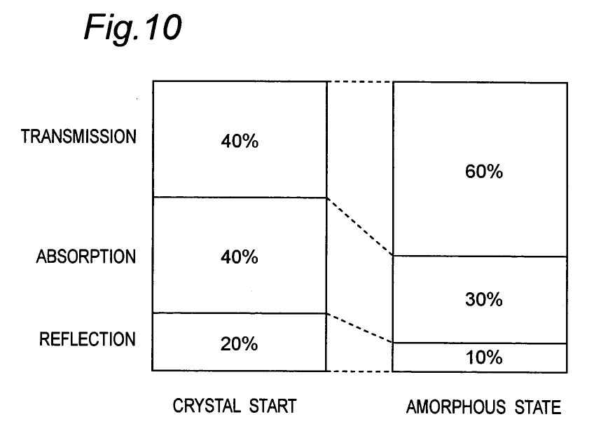

In the embodiment, address information is recorded in each sector by concavity and convexity pits. However, the address information may be formed by a method other than a method with concavity and convexity pits. For example, as shown in FIG. 3A and FIG. 3B, the address information (for example, digital signal) may be contained in the structure for forming the track itself. In this example, the address information (digital signal) is contained in the wobble shape of meandering track. FIG. 3A and FIG. 3B show wobble shapes 701 and 702 composing address information signals “0” and “1”, respectively. The difference in wobble shape allows the signals “0” and “1” to be distinguished. FIG. 3C shows the address information composed by combination of wobble shapes 701, 702 showing signals “0” and “1”. Thus, the address information may not be formed within each sector, or may be formed by method other than a method with concavity and convexity pits.

3. Recording Operation of Optical Disk Apparatus

Recording operation of the optical disk apparatus is explained. The following control can be achieved by the CPU 309 executing a specified program to appropriately control the laser driving circuit 304, servo control circuit 305, and so on.

The optical disk apparatus records dummy data together with the desired data when recording data in the first recording layer 102 (the recording layer closer to the laser beam source) of the optical disk 301. As a result, the first recording layer 102 is almost uniform in the entire recorded state (crystal state), and the intensity of light (transmissivity) passing through the first recording layer 102 and reaching the second recording layer 104 (the recording layer remote from the laser beam source) is made uniform, thereby removing the effects of recorded state of the first recording layer 102 to the reproduction signal from the second recording layer 104. Dummy data recording is specifically described below while referring to FIGS. 4A and 4B and FIGS. 5A and 5B.

(Dummy Data Recording)

FIG. 4A is a diagram showing a state of the first recording layer 102 in which data is recorded properly in a method without recording dummy data. FIG. 4B is a diagram showing the waveform of reproduction signal obtained from the reproduction of the second recording layer corresponding to the first recording layer 102 shown in FIG. 4A. That is, FIG. 4B shows the reproduction signal obtained by reflection of the light passing through the first recording layer 102 shown in FIG. 4A on the corresponding area of the second recording layer. As shown in FIG. 4B, it is apparent that the signal level is different between the reproduction signal from the area of the second recording formatting the optical disk. The object is achieved by recording the dummy data only once, but it is the same if the dummy data is recorded two or more times.

Laser power for recording dummy data is preferably lower than that for recording normal data so as not to erase the adjacent data or not to change the transmissivity in the address area.

Dummy data recording area includes the whole area of the test emission area 118, the whole area of the second gap area 119, and the remaining area excluding the unrecorded space portion corresponding to the first gap area before the address area of next sector from the buffer area 121. However, if there is no problem in signal reproduction even though the first gap area 117 is recorded with low power and the precision of address detection is somewhat lowered, dummy data may be recorded in the whole area of the first gap area 117 and buffer area 121. In the wobble shape address method explained in FIGS. 3A to 3C, the address information is not erased by dummy data recording, and hence the dummy data recording area becomes an area other than the user data area and it is more effective. Dummy data may be synchronizing signal or arbitrary random signal to be recorded at the beginning of the user data.

(Setting of Recordable Range on Second Recording Layer)

Setting of recordable range on the second recording layer 104 by the optical disk apparatus of the embodiment is explained. In the optical disk 301, data is recorded in block units, and one block is composed of 16 sectors.

FIG. 6A shows a case that recording in the first recording layer 102 ends in block units. FIG. 6B shows a reproduction signal waveform from the second recording layer 104 in the state shown in FIG. 6A.

A block 401 is an error correction block which is composed of 16 sectors, and added with codes for detection and correction of signal error during signal reproduction. A sector group 404 is a recorded sector with recorded data, and sectors 405 are unrecorded sectors in which data is not recorded.

In FIG. 6A, the whole area of the first recording layer 102 is recorded, and thus the power of the laser beam reaching the second recording layer 104 is uniform in the whole area and the reproduction signal waveform from the second recording layer 104 is free from distortion derived from the recorded state of the first recording layer 102. Accordingly, for recording the second recording layer 104, there is no problem even though recording is done at any radial position. Hence, the optical disk apparatus sets the whole area on the second recording layer 104 as recordable area 403. If the whole area of the first recording layer 102 is in unrecorded state, the recordable area 403 of the second recording layer should be the whole area.

Next, setting of recording range in the second recording layer 104 is explained when the remaining unrecorded area in the first recording layer 102 includes a few, that is, small number of sectors that does not satisfy one block, as shown in FIG. 7A. Suppose the whole area of the second recording layer is in unrecorded state. In FIG. 7A, the unrecorded area 405 of the first recording layer 102 is supposed to be 6 sectors (less than one block).

Since recording is done in block units, as shown in FIG. 7A, when the remaining of the unrecorded sector 405 is 6 sectors, being less than one block, further recording is not possible in the first recording layer 102. That is, the first recording layer 102 cannot be recorded completely up to the outermost circumference. Accordingly, shifting to the second recording layer 104, data is recorded, but since the first recording layer 102 includes recorded sectors 404 and unrecorded sectors 405 together, due to difference in the recorded state, the power of the laser beam 402 reaching the second recording layer 104 differs, and the reproduction signal waveform may be distorted.

Accordingly, the optical disk apparatus limits the recordable range 403 of the second recording layer 104 within the same range (area within the same radius) as the recording range of the first recording layer 102. The recordable range 403 is determined regardless of the recorded or unrecorded state of the second recording layer 104. As a result in the second recording layer 104, data can be recorded only in the uniform range of the power of the laser beam 402, effects of distortion of reproduction signal waveform can be lessened. Usually, the unrecorded portion of the first recording layer 102 is not less than one block, but a small fraction of unrecorded sector may occur in the final stage of recording, for example, if the sectors are not consumed as planned due to use of next sector in case of detection of defective sector due to effects of flaw or dust during recording operation.

Thus, since the recordable range of the second recording layer 104 is determined, the optical head 303 of the optical disk apparatus moves from the inner circumference to the outer circumference of the optical disk during recording of the first recording layer 102. When recording of the first recording layer is terminated, the optical head 303 starts recording of the second recording layer 104 from the position at which recording of the first recording layer is terminated.

Instead of making the recordable range 403 of the second 501 in the first recording layer 102 which is read put from the defect list area 108 into position information of the optical head 303, and determining the emitting range of laser beam 402 on the second recording layer 104 based on the position information. The information regarding the recording area 501 in the first recording layer 102 may be recorded in the defect list area 112, spare area 109 or spare area 113. Alternately, other area for recording only the information regarding the recording area 501 may be newly provided. The recording start position of the second recording layer 104 is not particularly specified as far as it is within the range of the recordable area 403. Recording of the recordable area 403 may be started from the position of the optical head at which the recording in the first recording layer 102 is terminated.

Thus, recording dummy data to the area of the sector in which data is not recorded usually allows fluctuations of transmissivity in the recording layer to be eliminated, and the power of the laser beam reaching other layers is made uniform. Further, limiting the recordable range in other layer enables recording and reproduction to be done in further stable conditions.

4. Variations

In the embodiment, only one example of determining the recording area 403 of the recording layer 104 is shown, but it may be realized by other method, such as focusing of the recording layer 104 at the same radial position after reproduction of the recording area 501, as far as the optical head position relation coincides in the recording layers 102 and 104.

Also in the embodiment, after overwriting data in the first recording layer 102, if the recording area 501 is expanded, the recordable range 403 is also expanded. If the whole area of the recording layer 102 is recorded by overwriting, the recording range of the second recording layer 104 is not limited.

In the embodiment, if the overwriting range in the first recording layer 102 is within the recording area 501 before overwriting, the recordable area 403 is not changed in the second recording layer 104. However, after finishing the overwriting in the first recording layer 102, recording in the second recording layer 104 may be started from the finishing position of the optical head.

In the above embodiment, description is made to the relation of positions of the outermost circumferences of recording areas in the first and second recording layers 102 and 104. Regarding the inner circumferences, the radius of the innermost circumference of the recordable area in the second recording layer 104 may be determined so as not to be less than the radius of the innermost circumference of the recording area in the first recording layer 102. Hence, the laser beam reaching the second recording layer 104 always passes through the recording area in the first recording layer 102.

In case that data recording is started from the second recording layer 104, after completion of the data recording to the second recording layer 104, data recording to the first recording layer is started, the following control may be done. Similar to the above embodiment, the recordable area of the first recording layer 102 can be limited to be equal to or greater than (preferably greater than) the recordable area of the second recording layer 104. That is, the radius of the outermost or innermost circumference of the recording area of the first recording layer 102 is determined as follows, so that the laser beam always passes through the recordable area in the first recording layer 102 and reaches the second recording layer 104. The radius of the outermost circumference of the recordable area in the first recording layer102 is defined to be equal to or more than the radius of the outermost circumference of the recording area in the second recording layer 104. The radius of the innermost circumference of the recordable area in the first recording layer102 is defined to be equal to or less than the radius of the innermost circumference of the recording area in the second recording layer 104.

(Industrial Utilization)

The invention is applicable to the optical disk apparatus for recording information in an optical disk capable of recording and reproducing information optically, especially a multi-layer optical disk having a plurality of recording layers, and the power of laser beam reaching the recording layer displaced at a farther position from a laser beam source can be made uniform, so that recording and reproduction can be done in further stable conditions.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2002-304791, filed on Oct. 18, 2002, which is expressly incorporated herein by reference in its entirety.

What is claimed is:

1. A method of recording data to an optical disk having a plurality of recording layers in which information can be recorded optically, wherein
the optical disk has a first recording layer and a second recording layer disposed at a farther position from a light source than the first recording layer,
the method comprises defining a radius of the outermost circumference of a data recordable range in the second recording layer to be equal to or less than a radius of the outermost circumference of an area in which data is recorded in the first recording layer, when recording data in the second recording layer.

2. The recording method according to claim 1, wherein the position of the optical head at the end of data recording in the first recording layer is the recording start position in the second recording layer.

3. The recording method according to claim 1, wherein the data is recorded in the optical disk in predetermined block units, and when the unrecorded area of the first recording layer becomes less than the size of one block during data recording operation in the first recording layer, the data recording layer is changed over to the second recording layer without recording in the unrecorded area.

4. The recording method according to claim 3, wherein a radius of the outermost circumference of the recordable range in the second recording layer is defined to be smaller than the radius of the outermost circumference of the data recorded area in the first recording layer by a predetermined distance.

5. The recording method according to claim 1, wherein a radius of the innermost circumference of the data recordable range in the second recording layer is defined to be equal to or larger than the radius of the innermost circumference of the data recorded area in the first recording layer.

6. The recording method according to claim 1, wherein a radius of the innermost circumference of the recordable range in the second recording layer is defined to be larger than the radius of the innermost circumference of the data recorded area in the first recording layer by a predetermined distance.

7. A method of recording data to an optical disk having a plurality of recording layers in which information can be recorded optically, wherein
the optical disk has a first recording layer, and a second recording layer disposed at a farther position from a light source than the first recording layer,
the optical disk has tracks divided into plural sectors, and each sector includes a buffer area at the end portion, and
the method comprises recording predetermined dummy data to the buffer area.

8. The recording method according to claim 7, wherein the sector further includes an address area having a sector identification signal, a user data area disposed before the buffer area for storing data, and a gap area disposed between the address area and the user data area.

9. The recording method according to claim 8, wherein the dummy data is recorded in all areas of the gap area and buffer area.

10. The recording method according to claim 8, wherein the dummy data is recorded in part of the gap area and buffer area.

11. The recording method according to claim 8, wherein, in the gap area or buffer area, the dummy data is not recorded to an area near the boundary of the address area and the gap area or buffer area.

12. The recording method according to claim 8, wherein the dummy data is equal to a synchronizing signal to be recorded at the beginning or end of the user data area.

13. The recording method according to claim 7, wherein in the sector the user data area for recording data is disposed before the buffer area, and in the buffer area, the dummy data is recorded at the end of the user data area with a predetermined distance apart from the data recorded, and when the data is recorded in a predetermined modulation rule, the predetermined distance is not larger than two times of the maximum mark length determined by the modulation rule.

14. The recording method according to claim 13, wherein the predetermined distance is not less than the minimum mark length determined by the modulation rule.

15. An apparatus of recording data to an optical disk having a plurality of recording layers in which information can be recorded optically,
the optical disk having a first recording layer, and a second recording layer disposed at a farther position from a light source than the first recording layer,
the apparatus comprising an optical head that emits a laser beam to the optical disk to record information, a driving controller that drives the optical head, and a controller for controlling the driving controller,
wherein, when recording data in the second recording layer, the controller conducts a control so that a radius of the outermost circumference of a data recordable range in the second recording layer is equal to or less than a radius of the outermost circumference of an area in which data is recorded in the first recording layer.

16. The recording apparatus according to claim 15, wherein the data is recorded in the optical disk in predetermined block units, and when the unrecorded area of the first recording layer becomes less than the size of one block during data recording operation in the first recording layer, the data recording layer is changed over to the second recording layer without recording in the unrecorded area.

17. The recording apparatus according to claim 16, wherein a radius of the outermost circumference of the recordable range in the second recording layer is defined to be smaller than the radius of the outermost circumference of the data recorded area in the first recording layer by a predetermined distance.

18. The recording apparatus according to claim 15, wherein a radius of the innermost circumference of the data recordable range in the second recording layer is defined to be equal to or larger than the radius of the innermost circumference of the data recorded area in the first recording layer.

19. The recording apparatus according to claim 15, wherein a radius of the innermost circumference of the recordable range in the second recording layer is defined to be larger than the radius of the innermost circumference of the data recorded area in the first recording layer by a predetermined distance.

20. An apparatus of recording data to an optical disk having a plurality of recording layers in which information can be recorded optically,
the optical disk having a first recording layer, and a second recording layer disposed at a farther position from a light source than the first recording layer, the optical disk having tracks divided into plural sectors, each sector including a buffer area at the end portion,
the apparatus comprising an optical head that emits a laser beam to the optical disk to record information, a driving controller that drives the optical head, and a controller for controlling the driving controller,
wherein the controller conducts the control so that predetermined dummy data is recorded to the buffer area.

21. The recording apparatus according to claim 20, wherein the sector further includes an address area having a sector identification signal, a user data area disposed before the buffer area for storing data, and a gap area disposed between the address area and the user data area.
